(19) United States
(12) Patent Application Publication
(10) Pub. No.: US 2011/0157896 A1
(43) Pub. Date: Jun. 30, 2011

(54) COLOR LED LAMP

(76) Inventor: CHIH-MING YU, HSINCHU CITY (TW)

(21) Appl. No.: 12/650,931

(22) Filed: Dec. 31, 2009

(51) Int. Cl. F21V 9/00

(52) U.S. Cl. 362/293; 362/311.02; 362/294

(57) ABSTRACT

A light diffusion bulb and a color filter bulb are used in a color LED lamp including a white or warm white LED having a power of at least 0.5 W. The light diffusion bulb and color filter bulb both are bounded to a base to enclose the LED. The light diffusion bulb scatters the light of the LED by a great number of particles such that the light diffusion bulb becomes a surface light source conforming to the geometric shape thereof for uniform illumination, and the color filter bulb filters the light of the LED to thereby determine the light color of the LED lamp. Alternatively, the light diffusion function and color filtering function are combined in a single bulb.

### FIELD OF THE INVENTION

The present invention is related generally to a light-emitting diode (LED) lamp and, more particularly, to a color LED lamp for emitting uniform and soft light.

### BACKGROUND OF THE INVENTION

A light-emitting diode (LED) is made of semiconductor material whose band gap determines the wavelength, and therefore the color, of the light emitted by the LED. During the early development stages, LEDs are made of gallium arsenide and thus could only emit infrared or red light. Now, with the advancement in material science, LEDs capable of emitting white light or other color light are commercially available. However, in order to manufacture LEDs of specific color light, specific recipe in semiconductor composition and process is required, or LEDs of different wavelengths are used to compound their light colors to produce the desired color, or fluorescent agent is sputtered or coated on a LED of a specific wavelength to transform the light from the original color to the desired color. Moreover, there are problems and difficulties for LEDs of certain special colors. For example, some pink LEDs are made by coating blue LEDs with a fluorescent paint or a nail polish, and the fluorescent paint or nail polish is likely to peel off. Some other pink LEDs are made by coating white LEDs with a pink phosphor or dye, and the pink color will fade within a short time. Some color LEDs are extremely difficult in manufacturing or require forbiddingly high production costs. In addition, LEDs manufactured in a same batch tend to differ in color, and the chances of color difference among LEDs manufactured in different batches for a same color are even higher. Manufacturers of color LED lamps not only are subject to the aforesaid disadvantageous factors, but also must prepare LEDs of various colors for manufacturing LED lamps of different hues.

On the other hand, as a LED is similar to a point light source, LED lamps produce glare. This is especially true in high-power applications, where the glare may cause eye discomfort very easily.

Furthermore, the light emission angle of a LED is generally less than about 120 degrees. Hence, compared with an incandescent lamp or a halogen lamp, a LED lamp has more of its light focused in the front field and has far less uniform distribution of light in lateral directions, resulting in a smaller illumination space.

The foregoing factors are unfavorable to the applications of LEDs in color lamps and need remedy.

### BRIEF SUMMARY OF THE INVENTION

It is an object of the present invention to provide a color LED lamp for emitting uniform and soft light and more particularly, to applications of high-power white or warm white LEDs.

According to the present invention, a light diffusion bulb and a color filter bulb are used in a color LED lamp including a white or warm white LED having a power of at least 0.5 W. The light diffusion bulb and color filter bulb both are bounded to a base to enclose the LED in such a manner that the light diffusion bulb is disposed between the color filter bulb and LED, or the color filter bulb is disposed between the light diffusion bulb and LED. The light diffusion bulb scatters the light of the LED by a great number of particles such that the light diffusion bulb becomes a surface light source conforming to the geometric shape thereof for uniform illumination. The color filter bulb filters the light of the LED to thereby determine the light color of the LED lamp.

According to the present invention, light diffusion and color filtering functions are combined in a bulb for a color LED lamp including a white or warm white LED having a power of at least 0.5 W. The bulb is bounded to a base to enclose the LED, filters the light of the LED, and scatters the light of the LED by a great number of particles such that the bulb becomes a color surface light source conforming to the geometric shape thereof for uniform illumination.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a schematic diagram of a first embodiment for optical design of a color LED lamp according to the present invention;

FIG. 2 is a schematic diagram of a second embodiment for optical design of a color LED lamp according to the present invention;

FIG. 3 is a schematic diagram of a third embodiment for optical design of a color LED lamp according to the present invention;

FIG. 4 is a schematic diagram of a fourth embodiment for optical design of a color LED lamp according to the present invention;

FIG. 5 is a schematic diagram of two embodiments for geometric design of a light diffusion bulb for a color LED lamp according to the present invention;

FIG. 6 is a schematic diagram of a first embodiment for a color LED lamp according to the present invention; and

FIG. 7 is a schematic diagram of a second embodiment for a color LED lamp according to the present invention.

### DETAILED DESCRIPTION OF THE INVENTION

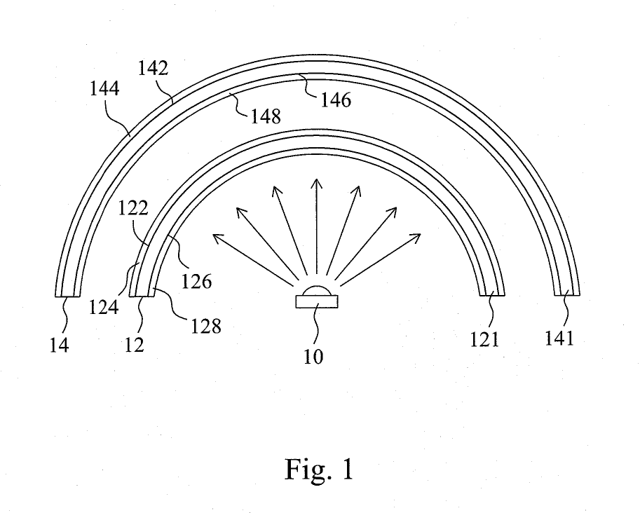

To begin with, the optical design of a color LED lamp according to the present invention is illustrated. As shown in FIG. 1, in front of a white or warm white LED 10, a light diffusion bulb 12 and a color filter bulb 14 are arranged in such a manner that the light diffusion bulb 12 is disposed between the LED 10 and color filter bulb 14, or the color filter bulb 14 is disposed between the LED 10 and light diffusion bulb 12. The white or warm white LED 10 is direct-current (DC) or alternating-current (AC) driven, has a power of at least 0.5 W, and serves to provide luminous flux. The light emission angle of the LED 10 depends on its optical design and is not subject to strict limitations. When lighted, the LED 10 will emit white or warm white light within its emission angle, and the light diffusion bulb 12 transforms the approximate point light source to a surface light source for uniform illumination. More specifically, the light diffusion bulb 12 uses a great number of particles for scattering the white or warm white light emitted by the LED 10, and after multiple irregular reflections, the light that propagates originally in a particular direction is scattered in various directions and in consequence, a uniform luminous surface conforming to the geometric shape of the light diffusion bulb 12 is obtained. In this embodiment, the light diffusion bulb 12 includes a transparent substrate 121 such as glass or acrylic, whose outer surface 122 has a light diffusion layer 124, or whose inner surface 126 has a light diffusion layer 128, or whose outer surface 122 and inner surface 126 have light diffusion layers 124 and 128, respectively. The light diffusion layer 124 or 128 is made by mixing silicone or transparent resin with particles of titanium dioxide, silicon dioxide, or other compositions and then spraying the mixture on the already formed transparent substrate 121. The color filter bulb 14 includes a transparent substrate 141 such as glass or acrylic, whose outer surface 142 has a color filter layer 144, or whose inner surface 146 has a color filter layer 148, or whose outer surface 142 and inner surface 146 have color filter layers 144 and 148, respectively. The color filter layer 144 or 148 includes pigment such as metal oxide pigment, coated on the already formed transparent substrate 141. When the LED 10 emits light, the white or warm white light passes through the light diffusion bulb 12 and is thereby softened and rendered uniform. After the diffused light passes through the color filter bulb 14, only light of a specific color remains, which color is determined by the color filter layer 144 and/or 148.

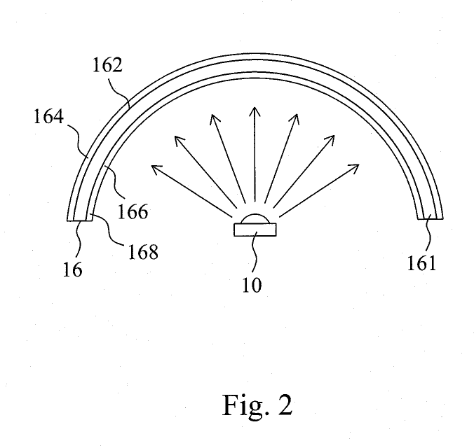

FIG. 2 is a schematic diagram of a second embodiment for optical design of a color LED lamp according to the present invention, which combines the light diffusion function and color filtering function into a single bulb 16 including a transparent substrate 161 such as glass or acrylic, by coating a color filter layer 164 on its outer surface 162 and a light diffusion layer 168 on its inner surface 166. The bulb 16 is prepared by coating the already formed transparent substrate 161 with pigment to form the color filter layer 164, and spraying the already formed transparent substrate 161 with a mixture of silicone or transparent resin and particles of titanium dioxide, silicon dioxide or other compositions to form the light diffusion layer 168. The white or warm white light emitted by the LED 10 is scattered by the great number of particles in the light diffusion layer 168 and, after multiple irregular reflections, changes its original propagation directions to various scattered directions. The diffused light then passes through the color filter layer 164, which determines the color of the outgoing light. In a different embodiment, both the color filter layer 164 and light diffusion layer 168 are formed on the outer surface 162 or the inner surface 166 of the transparent substrate 161. Alternatively, the color filter layer 164 and light diffusion layer 168 may be formed on each of the outer surface 162 and inner surface 166. It is also feasible to exchange the positions of the color filter layer 164 and light diffusion layer 168 such that the light diffusion layer 168 is disposed on the outer surface 162 of the transparent substrate 161 and the color filter layer 164 is disposed on the inner surface 166 of the transparent substrate 161.

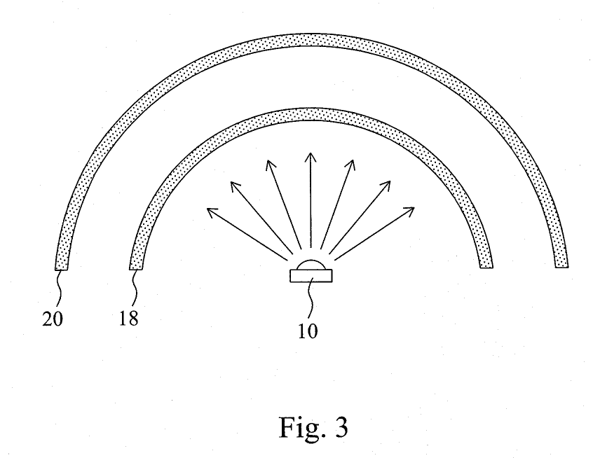

FIG. 3 is a schematic diagram of a third embodiment for optical design of a color LED lamp according to the present invention, in which a light diffusion bulb 18 is made by mixing a great number of particles of titanium dioxide, silicon dioxide, or other compositions into transparent material and then forming the mixture into shape, and a color filter bulb 20 is made by mixing pigment into transparent material and then forming the mixture into a colored transparent substrate. In this embodiment, the light diffusion bulb 18 is located between the LED 10 and color filter bulb 20. In other embodiments, however, the color filter bulb 20 is located between the LED 10 and light diffusion bulb 18.

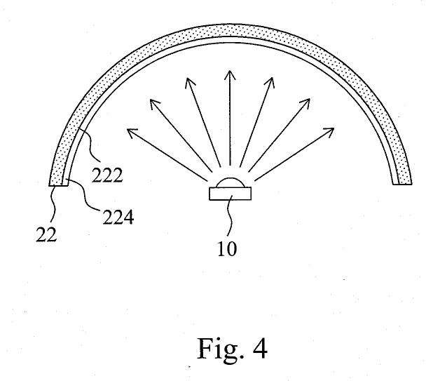

FIG. 4 is a schematic diagram of a fourth embodiment for optical design of a color LED lamp according to the present invention, in which a bulb 22 is made by mixing pigment into transparent material, forming the mixture into a colored transparent substrate, and spraying an inner surface 222 of the colored transparent substrate with a mixture of silicone or transparent resin and particles of titanium dioxide, silicon dioxide, or other compositions to form a light diffusion layer 224. In a different embodiment, the light diffusion layer 224 is formed on the outer surface of the colored transparent substrate or on both the inner and outer surfaces of the colored transparent substrate.

The above four embodiments demonstrate some typical ways to implement the light diffusion function and color filtering function, and anyone skilled in the art may have various modified or alternative designs based on the embodiments described above. For example, the light diffusion bulb 12 of FIG. 1 can be used in conjunction with the color filter bulb 20 of FIG. 3, or the color filter bulb 14 of FIG. 1 in conjunction with the light diffusion bulb 18 of FIG. 3. As another example, it is feasible to mix both the pigment and the great number of particles into transparent material and form the mixture into a bulb capable of both diffusing and filtering light.

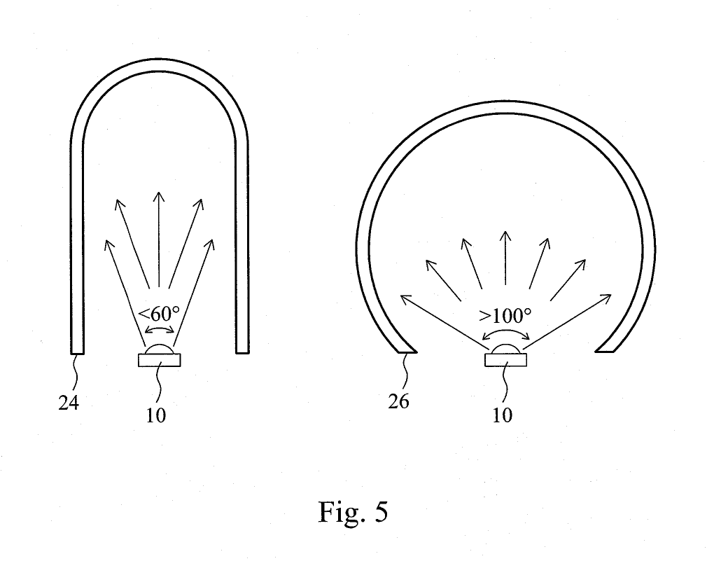

As shown in FIG. 5, preferably, a slender light diffusion bulb 24 is used with an LED 10 whose light emission angle is less than 60 degrees, and a spherical light diffusion bulb 26 is used with an LED 10 whose light emission angle is greater than 100 degrees. The geometric designs of these bulbs contribute to the formation of uniform luminous surfaces.

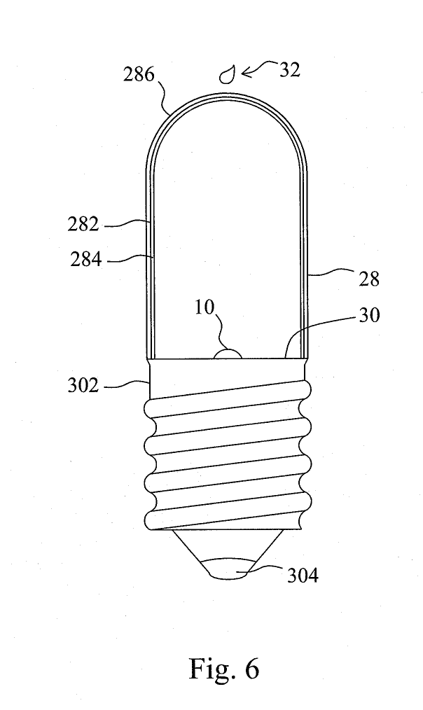

As shown in FIG. 6, for a color LED lamp, a bulb 28 is bounded to a base 30 to enclose a white or warm white LED 10. In this embodiment, the bulb 28 is prepared by spraying a light diffusion layer 284 on an inner surface 282 of a transparent substrate. As the bulb 28 and base 30 jointly enclose the LED 10, the bulb 28 when viewed from outside resembles a surface light source that provides uniform illumination. Thus, not only is glare eliminated, but also lateral illumination is improved, thereby enlarging the illumination space. Manufacturers of color LED lamps may fabricate semi-products having the aforesaid structure in advance and, after orders are received, coat an outer surface 286 of the bulb 28 with pigment 32 of the desired color to form the color filter layer. In other words, the manufacturers may mass-produce semi-products of a single structure that are ready to be processed into LED lamps of different colors, thereby substantially shortening the order-to-ship time. If a standard base is selected for the base 30, the color LED lamp according to the present invention can be used as a substitute for conventional color light bulbs, A “standard base” refers to a standardized base that can be inserted directly into a common base. A few examples of standard bases are the E12, E14, E17, E26, and E27 bases for incandescent light bulbs and the MR16 and GU10 bases for halogen light bulbs. The base 30 shown in FIG. 6 is a standard base for use with an incandescent light bulb and includes electrodes 302 and 304 that are electrically insulated from each other, and the electrode 302 is a cylindrical metal housing formed with a screw thread. The LED 10 is electrically connected between the electrodes 302 and 304.

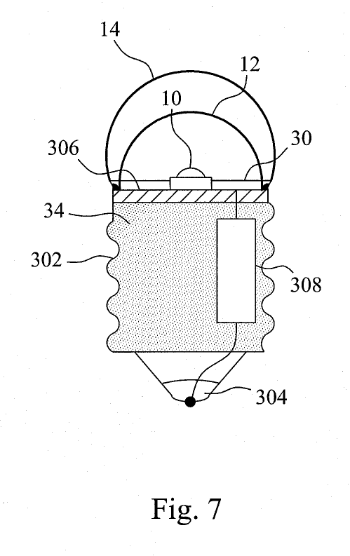

In U.S. patent application Ser. No. 12/457,718, the inventor of the present invention proposed a LED lamp for replacing conventional light bulbs, and the technique disclosed thereof is incorporated into an embodiment of the present invention as shown in FIG. 7. The color LED lamp shown in FIG. 7 includes the light diffusion bulb 12 and color filter bulb 14 of FIG. 1 and a standard base 30. In addition to the electrodes 302 and 304, the base 30 includes a circuit board 306 soldered to the electrode 302, as well as a resistor 308 having a resistance between 50 and 50000 ohm and disposed inside the electrode 302. An LED 10 is soldered to the circuit board 306. The light diffusion bulb 12 is bounded to the circuit board 306 by gluing or mechanical engagement, and the color filter bulb 14 is bounded to the top end of the electrode 302 by gluing or mechanical engagement. The resistor 308 has its two ends soldered to the circuit board 306 and electrode 304, respectively, so as to be connected in series with the LED 10 between the electrodes 302 and 304 to form a circuit loop. For enhancement of heat dissipation, thermally conductive and electrically insulative material 34 having a thermal conductivity ranging from 0.25 to 30 W/mK is filled inside the electrode 302 and in mechanical contact with the circuit board 306 and the electrode 302, thus providing a thermal channel for transferring heat from the LED 10 to the electrode 302 and consequently to the environment. The electrode 302, which is a screw metal housing having a large surface area, can effectively dissipate heat from the LED 10. Alternatively, the LED 10 can be directly placed in mechanical contact with the thermally conductive and electrically insulative material 34; or, a thermally conductive member can be used and have its two ends in mechanical contact with the LED 10 and the thermally conductive and electrically insulative material 34, respectively. For further details of the base 30 that facilitate heat dissipation from the LED 10, readers are referred to U.S. patent application Ser. No. 12/457,718. Manufacturers of color LED lamps may pre-fabricate semi-products without the color filter bulbs 14 and when orders are received, the appropriate color filter bulbs 14 are selected according to the desired color and bounded to the bases 30. Thus, the management of parts can be simplified, and the order-to-ship time significantly reduced.

As demonstrated by the foregoing embodiments, manufacturers of the color LED lamps according to the present invention only need one type of white or warm white LEDs and are no longer required to prepare LEDs of many different colors. When it is desired to produce LED lamps of a specific color, the manufacturers only have to select and then install color filter bulbs of that specific color. Consequently, production management is made easy, and associated costs can be reduced. In particular, the present invention enables the production of LED lamps of any colors and helps minimize the color difference among the LED lamps produced.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A color LED lamp comprising:
a DC or AC driven, white or warm white LED having a power of at least 0.5 W, for emitting light;
a base electrically coupled to the LED, for providing power for the LED;
a light diffusion bulb bounded to the base to thereby enclose the LED, for scattering the light by a great number of particles such that the light diffusion bulb becomes a surface light source conforming to a geometric shape thereof for uniform illumination; and
a color filter bulb bounded to the base, for filtering the light to thereby determine the light color of the LED lamp.

2. The LED lamp of claim 1, wherein the light diffusion bulb is disposed between the color filter bulb and LED.

3. The LED lamp of claim 1, wherein the color filter bulb is disposed between the light diffusion bulb and LED.

4. The LED lamp of claim 1, wherein the light diffusion bulb comprises:
a transparent substrate; and
a light diffusion layer containing the great number of particles, covering on either one or both of an outer surface and an inner surface of the transparent substrate.

5. The LED lamp of claim 4, wherein the light diffusion layer comprises a silicone or a transparent resin mixed with the great number of particles.

6. The LED lamp of claim 1, wherein the light diffusion bulb comprises a transparent substrate having the great number of particles therein.

7. The LED lamp of claim 1, wherein the LED has a light emission angle less than 60 degrees, and the light diffusion bulb has a slender shape.

8. The LED lamp of claim 1, wherein the LED has a light emission angle greater than 100 degrees, and the light diffusion bulb has a spherical shape.

9. The LED lamp of claim 1, wherein the color filter bulb comprises:
a transparent substrate; and
a color filter layer containing a pigment, covering on either one or both of an outer surface and an inner surface of the transparent substrate.

10. The LED lamp of claim 1, wherein the color filter bulb comprises a colored transparent substrate.

11. The LED lamp of claim 1, wherein the base comprises:
two electrodes electrically insulated from each other;
a resistor having a resistance between 50 and 50000 ohm, disposed inside the first electrode, and electrically connected in series with the LED between the two electrodes; and
a thermally conductive and electrically insulative material having a thermal conductivity between 0.25 and 30 W/mK, filling inside and mechanically contacting with the first electrode, to thereby provide a thermal channel for transferring heat from the LED to the first electrode for heat dissipation.

12. A color LED lamp comprising:
a DC or AC driven, white or warm white LED having a power of at least 0.5 W, for emitting light;
a base electrically coupled to the LED, for providing power for the LED; and
a bulb bounded to the base to thereby enclose the LED, for filtering the light and scattering the light by a great number of particles such that the bulb becomes a color surface light source conforming to a geometric shape thereof for uniform illumination.

13. The LED lamp of claim 12, wherein the bulb comprises:
a transparent substrate; and
a light diffusion layer containing the great number of particles, covering on either one or both of an outer surface and an inner surface of the transparent substrate.

14. The LED lamp of claim 13, wherein the light diffusion layer comprises a silicone or a transparent resin mixed with the great number of particles.

15. The LED lamp of claim 12, wherein the bulb comprises a transparent substrate having the great number of particles therein.

16. The LED lamp of claim 12, wherein the LED has a light emission angle less than 60 degrees, and the bulb has a slender shape.

17. The LED lamp of claim 12, wherein the LED has a light emission angle greater than 100 degrees, and the bulb has a spherical shape.

18. The LED lamp of claim 12, wherein the bulb comprises:
a transparent substrate; and
a color filter layer containing a pigment, covering on either one or both of an outer surface and an inner surface of the transparent substrate.

19. The LED lamp of claim 12, wherein the bulb comprises a colored transparent substrate.

20. The LED lamp of claim 12, wherein the base comprises:
two electrodes electrically insulated from each other;
a resistor having a resistance between 50 and 50000 ohm, disposed inside the first electrode, and electrically connected in series with the LED between the two electrodes; and
a thermally conductive and electrically insulative material having a thermal conductivity between 0.25 and 30 W/mK, filling inside and mechanically contacting with the first electrode, to thereby provide a thermal channel for transferring heat from the LED to the first electrode for heat dissipation.
